(19) United States
(12) Patent Application Publication
(10) Pub. No.: US 2009/0138146 A1
(43) Pub. Date: May 28, 2009

(54) AUTOMATIC PILOT DEVICE AND METHOD WITH INSTINCTIVE TARGET LOCK-ON

(75) Inventors: Gilles COCHET, Miremont (FR); Yannick Meret, La Salvetat Saint Gilles (FR); Benoit Tavernier, Toulouse (FR); Jerome Birre, Bruguieres (FR); Damien Brocas, Tournefeuille (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/275,574

(22) Filed: Nov. 21, 2008

(30) Foreign Application Priority Data
Nov. 23, 2007 (FR) 07 08214

(51) Int. Cl. G05D 1/00

(52) U.S. Cl. 701/11

(57) ABSTRACT

The invention relates to automatic pilot devices on board aircraft, and more particularly aircraft of the maritime patrol or surveillance type. The invention is a device able to be engaged instinctively, calculating at least two flight path modes, the first one being a horizontal circular flight path around a location point and the second one being the overflying of a location point according to a heading chosen on a horizontal line, and making it possible to direct the aircraft automatically according to these two flight paths.

### RELATED APPLICATIONS

The present application is based on, and claims priority from, French Application Number 07 08214, filed Nov. 23, 2007, the disclosure of which is hereby incorporated by reference herein in its entirety.

### FIELD OF THE INVENTION

The field of the invention relates to automatic pilot systems for aircraft and in particular for those used for rescue or surveillance maneuvers. The invention applies particularly to surveillance aircraft or to maritime patrol aircraft.

### BACKGROUND OF THE INVENTION

In the context of surveillance or rescue missions, aircraft often have to follow flight paths specific to their mission. For example, during a rescue mission, the aircraft can have to carry out flights over a rescue vessel out at sea in order to drop teams as close as possible to the vessel and, during a surveillance mission, it must notably follow circular flight paths in order to observe the zone. For these two types of maneuver, the pilot has the mission of piloting the aircraft by carrying out passes as close as possible to the target, regarding overfly altitude and distance with respect to the target. Moreover, the pilot must maintain a regular flight path whilst observing the zone in order to then carry out the adapted plan of action.

Aircraft have several electronic flight assistance systems for piloting the aircraft according to predefined flight paths and for assisting the pilot during the flight. They comprise a flight management system, generally denoted by FMS, the acronym for “Flight Management System”, and an automatic pilot device. Current FMS systems used in the context of SAR (Search and Rescue) missions for example have interfaces with the automatic pilot systems in order to define circular flight paths but the pilot must, in order to use them, predefine and program the points to be flown over. This procedure is particularly irksome for the pilot because it places an additional workload on him and prevents him from concentrating fully on the task of observation of the zone.

In the prior art there is also a patent application WO2007058643A1 describing a system intended for aircraft, notably for surveillance drones, and making it possible to control them so that they automatically follow circular flight paths according to parameters to be defined by the pilot. This system calculates a flight path automatically but again requires that the person controlling the aircraft predefines at least a position and a flight path radius. This system has disadvantages. Firstly, in the context of an observation mission, the pilots do not generally know the exact position of the target and must arrive at the target in order to define the position. It is therefore necessary to retrieve the precise location coordinates and to then to enter them into the system, which necessitates an additional task for the pilot. Secondly, pilots need to define a flight path as close as possible to the target in order to position themselves in the best observation conditions. This radius depends on the flight envelope of the aircraft, that is to say the safety conditions and attitudes of the aircraft, and on its speed. According to these flight parameters, the pilot is confronted with limitations in defining the value of the radius of the circular flight path. In fact he cannot enter a radius below a certain threshold into the system and this limitation necessitates that he must determine a radius value adapted to the flight situation. Despite the automatic calculation of the circular flight path, the maneuver still requires a pre-programming by the pilot, thus distracting him from his observation task.

### SUMMARY OF THE INVENTION

More precisely, the invention relates to an automatic pilot device comprising a first flight path computer, at least one location designation device and an automatic pilot activation interface characterized in that the flight path computer has at least two flight path modes, the first one being a circular flight path around a location point and the second one being the overflying of a location point, and when one of the modes is activated, the location designation device provides the flight path computer with a location point allowing it to automatically program an optimal flight path of the selected mode in the automatic pilot device.

Advantageously, the flight path of the first mode is such that the radius of the flight path remains continuously minimal as a function of the speed variations of the aircraft whilst complying with the flight envelope of the aircraft. The pilot is thus as close as possible to the observation zone without having to predefine a parameter of the flight path.

Advantageously, the flight path of the second mode is such that the frequency of flying over the point is maximal whilst complying with the flight envelope of the aircraft. The aircraft carries out overflights of the target continuously whilst minimizing the time between each overflight.

The points to be flown over in these two flight path modes are calculated automatically by the device as a function of the flight envelope of the aircraft, and of the point taken, simply by activation of the automatic pilot. Thus the pilot does not need to prepare a flight path previously.

The invention also relates to an automatic pilot method for an aircraft comprising an automatic pilot system having at least two flight path modes predefined according to a location point, a flight path computer and at least one location designation device, characterized in that when the automatic pilot system is activated in one of the flight path modes:
The automatic pilot device controls the aircraft such that it carries out a maneuver in order to join the calculated flight path in an optimal manner, the location point being the position of the aircraft at the time of activation of said automatic pilot system;
If the first mode is selected, and as long as the automatic pilot device is activated, the automatic pilot device controls the aircraft such that it follows a circular flight path around the location point according to a radius of circle calculated by the flight path computer;
If the second mode is selected, and as long as the automatic pilot device is activated, the automatic pilot device controls the aircraft such that it flies over the location point according to a heading and with an overflight frequency calculated by the flight path computer.

The invention is particularly advantageous for surveillance aircraft or for maritime patrol aircraft. In order to engage the target overfly or circling maneuvers, the pilot has only to activate the automatic pilot device in the desired flight path mode at the time he passes over the target. In an example interface, the system is engaged with a simple push-button and the flight path computer then determines the flight path to be followed. It is a device making it possible to make use of several different flight path modes and to engage them instinctively with no previous preparations. For example, in the context of a mission to search for survivors of shipwrecks at sea, the aircraft is in a first phase of searching for persons. The pilot does not generally have any indication regarding the exact position of the survivors. He cannot therefore previously define the position about which the aircraft follow overflight or circling flight paths. The invention is advantageous because once the target is within visual range, it suffices for the pilot to overfly the target for a first time, to engage the automatic pilot system in one mode at the moment when the aircraft is over the target and the latter then automatically flies the aircraft along the optimal flight path. For the circular flight path, the radius is determined automatically in order to be as small as possible and, for the overflight mode, the aircraft is directed such that the time between each overflight is minimal. These characteristics depend on flight parameters such as, for example, the flight envelope of the aircraft, the flight speed and the flight altitude.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and is several are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is the functional block diagram of the device according to the invention

FIG. 2 shows an example of an interface for engaging automatic pilot modes

FIG. 3 represents a first automatic pilot mode describing a circular flight path about a target

FIG. 4 represents a second automatic pilot mode describing a target overflight flight path.

### DETAILED DESCRIPTION OF PREFERRED EMBODIMENT

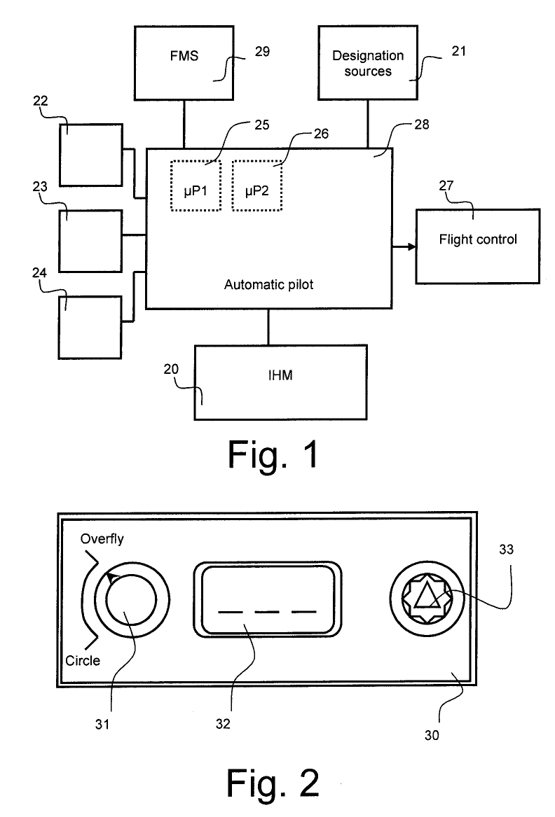

The invention applies to aircraft comprising the device according to the invention carrying out the method according to the invention. It is intended particularly for patrol or surveillance aircraft. In fact, during their missions, these aircraft often have to fly circular flight paths around a target or overflights of the target. Generally, these operations take place in difficult meteorological conditions: strong winds, rough sea. At the same time as the execution of these maneuvers, the crew must observe the zone in order to assess how to operate in the zone. The invention is a device allowing the pilot to engage the automatic pilot very quickly in order that it automatically follows the flight paths adapted to the situation. The automatic pilot device 28 according to FIG. 1 comprises several flight path computers 25, 26 and sends instructions to the flight control systems represented by the block 27. These computers define the flight paths according to control signals coming from the control interface 20 and according to flight parameters coming from the flight management system 29 and from sensors 22, 23, 24 which are the anemometric system, the inertial control and the altitude control respectively. The control signals coming from the control interface 20 are the automatic pilot engagement signal, the selected mode signal and the heading signal chosen for the overflight flight path mode.

FIG. 2 shows, in a non-limiting way, an example of a control interface 30 of the invention. The automatic pilot device 28 is activated by means of the control interface 30 comprising at least an automatic pilot mode switch 31 and a flight path mode selector. This interface 30 is connected directly to the flight path computer 25 if this computer is outside of the automatic pilot device or is connected to the automatic pilot device 28 if the calculation function is integrated in the automatic pilot device. The push button 31 makes it possible to engage the automatic pilot mode and, at the same time, to select the mode. In this example, it is a two-position rotary push button making it possible to choose between flying over the target, the “Overfly” mode, and a circular flight path around the target, the “Circle” mode. The knob 33 is a heading selector in “Overfly” mode and the screen 32 is an overflight heading display in “Overfly” mode. This simple example of an interface allows the pilot to engage the automatic pilot with a single pushing of the button 31 and at the same time rotating it in order to choose the mode. In the “Overfly” mode, he only has additionally to select the overflight heading. The pilot is thus capable of activating the flight paths instinctively and can concentrate on observation of the zone. Once the mode is engaged, the device will retrieve the location of the point by means of a designation source 21. This designation source 21 can be an inertial and/or a GPS system providing the coordinates of the location point of the aircraft at the moment of overflying the target. It can also be a radar giving the position of a target moving at low speed and allowing the aircraft to adapt its flight path according to the movement of that target.

Advantageously, the automatic pilot device 28 also comprises at least a second flight path computer defining a third flight path mode able to be coupled with the first two flight path modes. The computer 25 calculates the flight paths of the two modes according to the invention. The computer 26 produces a third flight path mode. The computers 25, 26 can be coupled in order to produce combinations of flight paths. For example, this third mode can be an optimal vertical flight path according to a selected altitude or a roll decoupling mode. This third flight path mode is defined by the computer 26. More generally, the invention can be coupled with several flight computers in order to take advantage of already existing flight path modes. By way of example, according to FIG. 1, these computers 25 and 26 are located in the automatic pilot device 28 but, depending on the hardware architecture, can be located in a separate electronic unit or in the flight management system 29. In the case in which these computers 25 and 26 are located in separate electronic units or in the flight management system, they send control signals to the automatic pilot device.

Advantageously, the automatic pilot device 28 also comprises a flight safety limits tightening system. This system allows a significant lowering of the overflight altitude notably by reducing the roll control limits of the aircraft. In this way, the flight maneuver range is reduced and thus reduces the response time of the aircraft to the pilot's commands in order to correct a behavior of the aircraft which is approaching a dangerous attitude. This system is useful because, for surveillance or rescue missions, it is advantageous for the aircraft to be able to descend to the lowest possible altitude.

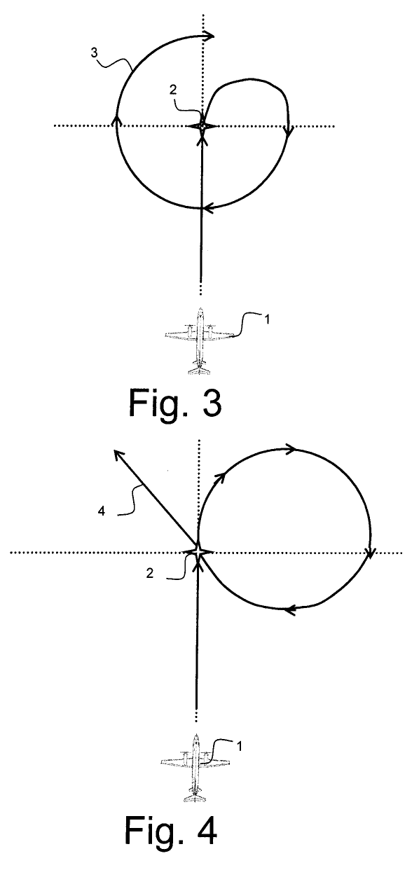

The block 25 is dedicated to calculating the flight paths according to the invention. FIG. 3 shows a first circular flight path 3 mode of an aircraft 1 around a location point 2. This flight path mode is used when, during a surveillance mission for example, the aircraft must therefore fly a circular flight path around the location point in order that the crew is in a position to observe the zone. In this type of situation, the aircraft arrives over the area, the pilot then locates the target more precisely and then carries out a first pass over the target. At this time, the pilot engages the automatic pilot device in the circular flight path mode by pressing the switch 31. The flight path computer 25 then defines the radius of the flight path as a function of the position taken by the designation system 21, of the flight speed and of aircraft parameters. The radius is calculated such that the aircraft circles the target as closely as possible in order that the crew can observe the zone in the best conditions. Just after the engagement of the automatic pilot, the aircraft joins the circular flight path 3 and follows it as long as the automatic pilot device is kept activated. The flight path radius is continuously optimized according to speed variations of the aircraft. In order to deactivate it, it suffices for the pilot to operate the switch 31. It is possible for example to couple this flight path mode with a vertical flight path already existent in the automatic pilot device.

FIG. 4 shows the second flight path mode 4 carrying out an overflight of the target with a heading of 45°. In this flight path mode, the automatic pilot takes into account the wind in order to optimize the overflight of the point 2. In the case of a target drifting at sea, it generally moves in the direction of the wind. The automatic pilot chooses the heading by default according to the direction of the wind in order that the target remains aligned with the aircraft heading during the joining operation. The heading can also be chosen by the pilot by means of the knob 33. The interface is designed such that the operation to be carried out by the pilot is not difficult.

The invention can also be applied to aircraft of the drone type comprising the device according to the invention and carrying out the method according to the invention. In order to apply it to the drone, the invention must be connected to a communication system allowing the remote activation of the automatic pilot device.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. An automatic pilot device comprising:
a first flight path computer,
at least one location designation device; and
an automatic pilot activation interface, wherein the flight path computer has at least two flight path modes, the first mode being a circular flight path around a location point according to a radius of circle calculated by the flight path computer and the second mode being the overflying of a location point according to a heading and with an overflight frequency calculated by the flight path computer, and when one of the modes is activated, the location designation device provides the flight path computer with a location point allowing it to automatically program an optimal flight path of the selected mode in the automatic pilot device.

2. The device as claimed in claim 1, wherein the flight path of the first mode is such that the radius of the flight path remains continuously minimal as a function of the speed variations of the aircraft while complying with the flight envelope of the aircraft.

3. The device as claimed in claim 2, wherein the flight path of the second mode is such that the frequency of flying over the point is maximal while complying with the flight envelope of the aircraft.

4. The device as claimed in claim 3, wherein the automatic pilot device also comprises at least a second flight path computer defining a third flight path mode able to be coupled with the first two flight path modes.

5. The device as claimed in claim 4, wherein the automatic pilot device also comprises a flight safety limits tightening system.

6. The device as claimed in claim 5, wherein the automatic pilot activation interface comprises at least an automatic pilot mode switch and a flight path mode selector.

7. An automatic pilot method for an aircraft comprising an automatic pilot device having at least two flight path modes predefined according to a location point, a flight path computer and at least one location designation device, wherein when the automatic pilot system is activated in one of the flight path modes:
the automatic pilot device controls the aircraft such that it carries out a maneuver in order to join the calculated flight path in an optimal manner, the location point being the position of the aircraft at the time of activation of said automatic pilot system;
if the first mode is selected, and as long as the automatic pilot device is activated, the automatic pilot device controls the aircraft such that it follows a circular flight path around the location point according to a radius of circle calculated by the flight path computer;
if the second mode is selected, and as long as the automatic pilot device is activated, the automatic pilot device controls the aircraft such that it flies over the location point according to a heading and with an overflight frequency calculated by the flight path computer.

8. The method as claimed in claim 7, wherein the automatic pilot system is activated by means of a control interface included in an automatic pilot device having
a first flight path computer,
at least one location designation device; and
an automatic pilot activation interface, wherein the flight plan computer has at least two flight path modes, the first mode being a circular flight path around a location point according to a radius of circle calculated by the flight path computer and the second mode being the overflying of a location point according to a heading and with an overflight frequency calculated by the flight path computer, and when one of the modes is activated, the location designation device provides the flight path computer with a location point allowing it to automatically program an optimal flight path of the selected mode in the automatic pilot device;
wherein the flight path of the first mode is such that the radius of the flight path remains continuously minimal as a function of the speed variations of the aircraft while complying with the flight envelope of the aircraft;
wherein the flight path of the second mode is such that the frequency of flying over the point is maximal while complying with the flight envelope of the aircraft;
wherein the automatic pilot device also comprises at least a second flight path computer defining a third flight path mode able to be coupled with the first two flight path modes;
wherein the automatic pilot device also comprises a flight safety limits tightening system;
wherein the automatic pilot activation interface comprises at least an automatic pilot mode switch an a flight path mode selector.
